(19) United States
(12) Patent Application Publication
(10) Pub. No.: US 2018/0058541 A1
(43) Pub. Date: Mar. 1, 2018

(54) Self-Actuating Line-Gripping Device for Adjustably Securing a Line to a Tie-Down

(71) Applicant: Boynton Brett, Houston, TX (US)

(72) Inventor: Boynton Brett, Houston, TX (US)

(21) Appl. No.: 15/683,752

(22) Filed: Aug. 22, 2017

Related U.S. Application Data
(60) Provisional application No. 62/378,330, filed on Aug. 23, 2016.

(51) Int. Cl. F16G 11/03; B63B 21/04; F16G 11/10

(52) U.S. Cl. CPC F16G 11/03; F16G 11/106; B63B 21/04

(57) ABSTRACT

Disclosed is a self-engaging, line-gripping device for adjustably securing a line to a tie-down. The device has a housing with a front head and a back body portion, a line-gripping mechanism integrated within the back portion, and a separate line holding member mounted on its surface. A line through passage goes through the back portion (including the line-gripping mechanism) and out front portion, the through passage for receiving a line into one end and passing it out the other end. The gripping mechanism is normally self-engaged to hold a received line in engagement with internal gripping means. The mechanism is released to load a line in the device by manually depressing a release plunger on the body portion. The line holding member has an internal channel which freely passes the line, and useful for forming a loop in the line and for securing the bitter-end of the line.

### CONTINUITY DATA

The present invention claims the benefit of prior filed U.S. Provisional Patent Application Ser. No. 62/378,330 filed 23 Aug. 2016, which application is included herein by reference in its entirety.

### FIELD OF THE INVENTION

The present invention is in the field of marine vehicles and accessories, and fittings specific thereto (Class 114). Specifically, the subject matter of the present invention relates to mooring devices for securing the marine vehicle, while in the water, to another structure, such as a float, a dock, a tie-down, a rail, a fender, etc. (subclass 230.1).

### REFERENCE NUMERALS

L Overall device length
HW Head width
LP Line passage diameter
LC Line channel diameter
BL Body length
RH Release plunger height
RW Release plunger width
RD Release plunger depth/thickness
TR Tab reach
F1 Plunger biasing force
F2 Manual operating force
10 Adjustable line/rope gripping device
12, 12a Gripping device housing
14, 14a Head portion contact/impact, bumper/fender
16 Body portion
18 Housing line through-passage
20 Line-grip release plunger
22 Housing left side
24 Housing right side
26 Head front-end
28 Housing back-end
30 Line holding member
32, 32a Line holding channel
34 Line-gripping/friction means
36 Release plunger well
50 Line-gripping mechanism
52 Release plunger line port
54 Biasing means spring
56 Spring receiver/retainer well
58 Release plunger stop tab
60 Release plunger travel stop shoulder
62 Release plunger line-gripping features
64 Bias spring seat stub
66 Plunger front-surface
68 Plunger back-surface
70 Plunger bottom surface
72 Plunger top surface
90 Line/rope
92 Line/rope bitter-end
96 Tie-down means (e.g., mooring/docking cleat)
98 Tie-down aperture

### SUMMARY OF THE INVENTION

The present invention is an adjustable, line-gripping device for securing a rope or a line to a tie-down. The present gripping device is adjustable in that it may be positioned substantially anywhere along the length of the line to form a loop in the line that may be secured to a tie-down. As used herein, a tie-down is a stationary ring, post, or the like to which items are secured with a line or rope. As an example, it is intended that the adjustable gripping device may be practiced to secure a boat's docking line to a mooring cleat, mooring post, mooring ring (or any other tie-down means) on the boat and/or on a dock, to secure the boat to the dock. In another example, the adjustable gripping device may be similarly practiced to attach a fender to a tie-down means on a boat or on a dock.

Typically, the adjustable line-gripping device is practiced proximate the bitter-end of the line or rope. In one application, if the tie-down is a dock cleat with an aperture through which the dock line can be passed, the bitter-end of the dock line (the end that is not secured, e.g. to a boat) is first passed through the cleat aperture. The bitter-end of the dock line is then fed through the front-end of the gripping device in the direction away from the tie-down, and the device is allowed to lock in place. In an embodiment of the line-gripping device practiced in this manner, the head or front-end of the device is larger than the tie-down aperture, and the head is disposed and adapted to engage the tie-down aperture without passing through.

In another application, the bitter-end of a dock line is first fed through the gripping device in the direction toward the tie-down. A length of the bitter-end of the dock line is then looped and fed back through the line holding channel on the gripping device, and the bitter-end of the line is then knotted (or otherwise fixed) to prevent it from pulling back through the device's line holding channel. The loop thus formed may be used to secure the dock line to a cleat or other tie-down means. Additionally, if the tie-down is engaged with a simple single loop of the dock line, the line-gripping device may be unlocked, and the dock line may be drawn through the line-gripping device to adjust the point-to-point length of the line as desired, and the gripping device allowed to locked again. Once the present adjustable line-gripping device is in place, it can easily be adjusted by a user to lengthen or shorten the point-to-point length of the dock line as desired.

The present line-gripping device for adjustably securing a line to a tie-down generally comprises a device housing, a line-gripping mechanism integral within the device housing, and a line holding member integrally mounted to the device housing. The device housing has a bumper front part, a substantially cylindrical body part with a line through-passage from a back-end portion of the housing body through a front-end portion of the bumper front part. The line through-passage is adapted receive to a length of line or rope into one of its end portions and pass the line out through the other end of the passage. The line-gripping mechanism has a hand operated release plunger disposed in a plunger-well in the device housing. The line-gripping mechanism is normally biased in an engaged condition and is manually operated to release it from the engaged condition by pushing down on the mechanism's release plunger. When the plunger is released, the gripping mechanism automatically returns to an engaged condition.

The automatic engagement of the gripping mechanism is accomplished by a spring biasing means, which acts on the release plunger to hold it in the normally engaged condition. A release plunger line-port passes through the release plunger from its front-surface to its back-surface. The line-port is partially offset from the line through-passage of the device housing, and disposed to normally hold a line or rope passing through the line device through-passage in frictional engagement with friction surfaces of the device housing and the release plunger.

A line holding member is mounted to an external surface of the cylindrical body part, the line holding member has an internal holding through channel with two channel-ends, and adapted to receive and freely pass the line/rope through either channel-end. The line holding member in combination with the line through-passage are adapted to form a loop in the line at the front part of the line-gripping device. These elements in combination providing for adjustably securing the line/rope to a tie-down.

### BRIEF DESCRIPTION OF THE DRAWINGS

FIGS. 1A & 1B, respectively are (A) a perspective view and (B) a front elevation view of the adjustable line-gripping device of the present invention for securing a line or rope to a tie down. Note that in this embodiment, the housing is practiced in left-side and right-side housing members.

FIG. 1C is a schematic drawing of a preferred embodiment of the present adjustable line-gripping device in use to secure one end of a mooring line to a docking cleat.

FIGS. 2A & 2B respectively are side elevation views of: a housing left-side member's (A) outer surface and (B) inner surface, showing the line-gripping mechanism in place.

FIG. 2C is a schematic view of the line-gripping mechanism of FIG. 2B.

FIGS. 3A & 3B respectively are: (A) a perspective view of the inner surface and (B) a front elevation view of a housing left-side member.

FIGS. 4A & 4B respectively are side elevation views of: a housing left-side member's (A) outer surface and (B) inner surface, showing an alternative embodiment of the line holding member of the body-portion of the device housing.

FIG. 4C is a side elevation view of the device housing member of FIGS. 4A & 4B showing an alternative embodiment of the head-portion of the line-gripping device.

FIGS. 5A & 5B respectively are: (A) a back perspective view and (B) a front elevation view of the release plunger of the line-gripping mechanism.

FIGS. 5C & 5D respectively are: (C) a bottom plan view and a side elevation view of the release plunger.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

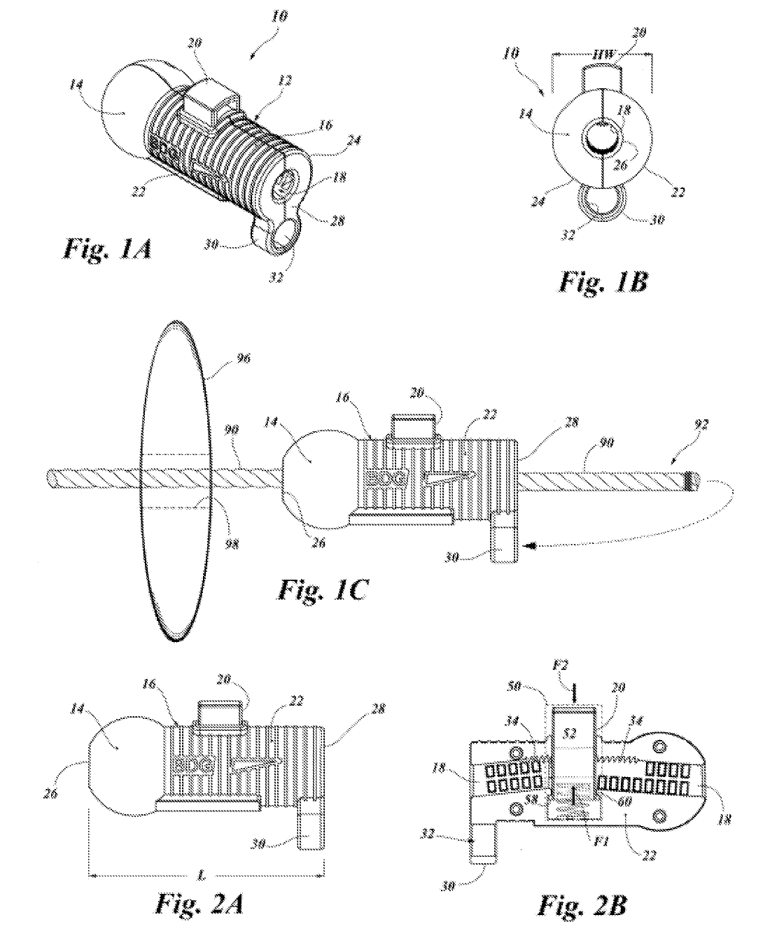

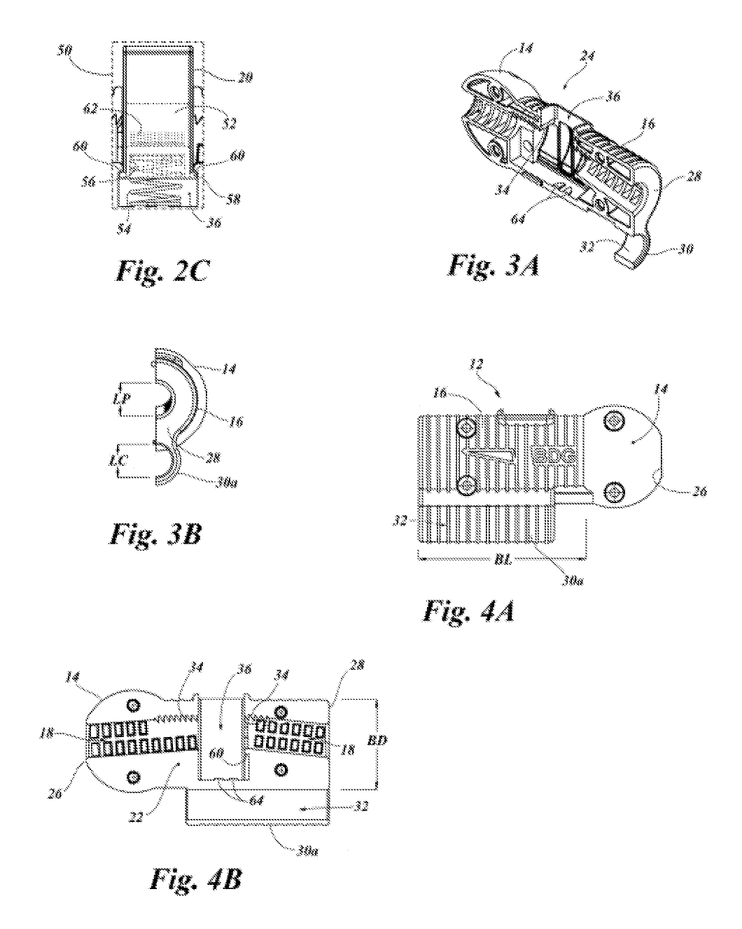

The present invention is an adjustable, self-actuating line-gripping device 10 for adjustably securing a line to a tie-down 96. The line-gripping device 10 is adjustable in that it may slid into different locations along a line or rope loaded into the gripping device 10 without removing the gripping device 10 from the line. The line-gripping device 10 is self-actuating in that the gripping device 10 is normally in an actuated or engaged condition, that is, if a line is received into the gripping device 10, the device is actively gripping the received line, unless a user is actively depressing the release plunger. As illustrated in FIG. 1 and FIG. 2, the primary components of the gripping device 10 consist of a device housing 12, a line-gripping mechanism 50 integrated within the device housing 12, and a line holding member 30.

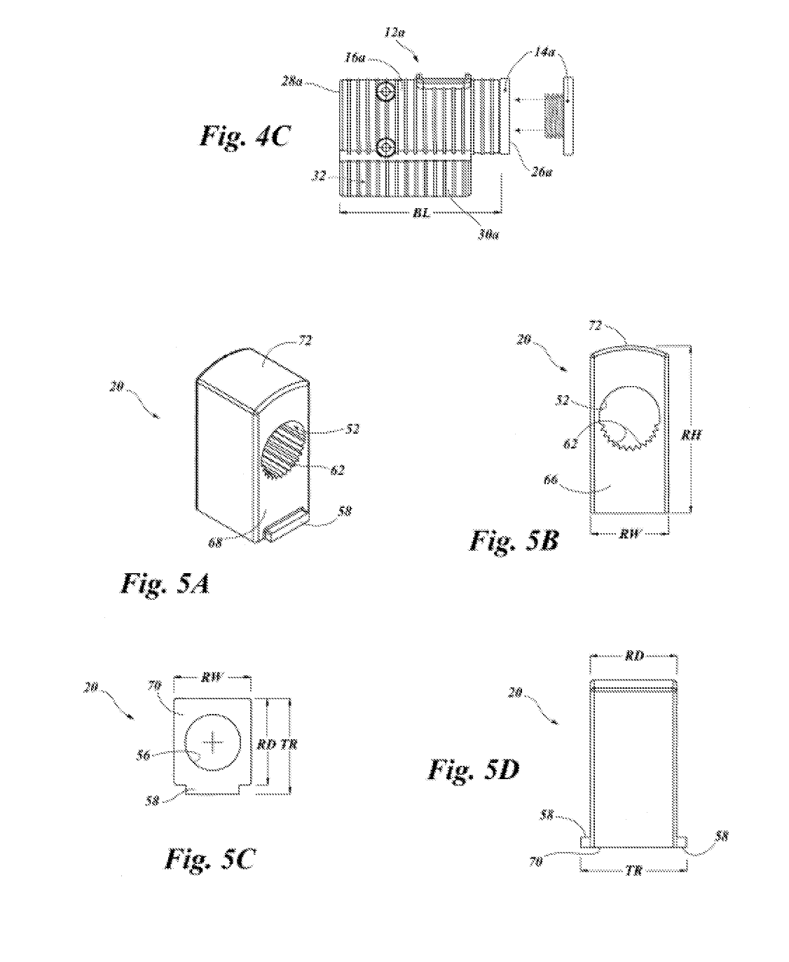

For the purpose of illustration, the device housing 12 in the embodiments presented in the figures is shown in two parts, so that internal features of the line-gripping device 10 and their relationships may be best understood. As exemplified in FIGS. 1A & 1B and in various other figures, the device housing 12, in a preferred embodiment, was practiced in two parts: a housing left side 22 and a housing right side 24. However, it is within the skill of the ordinary practitioner in the art of cast/injection molding and/or machine fabrication to practice the device housing 12 as a single part or in more than two parts. See FIG. 3A exemplifying a housing part configured suitably for an injection molding process, and see FIG. 4C exemplifying a housing configured in three parts. The device housing 12 has a head-portion 14, and a substantially cylindrical body portion 16 (see FIGS. 1A & 1B). The overall device length L is the distance from the head portion front-end 26 to the body portion back-end 28 (see FIG. 2A). An overall length L may be selected based on the intended modes of manual operation of the line-gripping device 10—e.g., single-handed (see FIG. 1A), a two handed grip (not shown), or to have an extended reach (not shown). In FIG. 4C, the device housing 12a essentially consists of a separate head portion 14a and a body portion 16a. The body portion 16a has a fore-end 26a and a back-end 28a; and a body left side and a body right side. Additionally, the fore-end 26a and a back-end 28a of the body portion 16a may be threaded or otherwise adapted to receive a complementarily adapted separate head portion 14a (as exemplified in the figure), or other similarly adapted element feature.

The housing head portion 14 can serve an “impact” means for when the gripping device 10 physically contacts a metal tie-down device. When intended for use as an impact surface, the housing head portion 14 has a head width HW and cross-section selected such that the housing head portion 14 will not pass through a tie-down 98 (see FIG. 1C) of an intended size and/or shape to which it is attached. Additionally, the housing head portion 14, in such case, may be comprised of a suitably impact resistant material. In the embodiment illustrated in FIGS. 1A-1C, the head portion 14 of the device housing 12 had a bulbous configuration, as being generally more favorable to withstanding impact with a metal docking cleat. However, the housing head portion 14 may have alternative configurations. A non-impact configuration example is shown in FIG. 4C, where the housing head portion 14a is configured differently for an application where the line gripping device 10 is not intended to physically contact a metal tie-down 96, such as a dock cleat. In this embodiment, the housing head portion 14a is comprised of a “bumper” material (e.g., plastic, rubber, etc.) that will not mar a (boat) surface, which it might contact during use. For this intended use, the head portion 14a may have a diameter that is slightly larger than the adjacent body portion 16a of the gripping device housing 12a.

In the embodiment in the figure, the head portion 14a element is exemplified as threaded, and is removable and replaceable with a similar or different head portion 14. A threaded receiver in the body portion 16a for receiving the head portion 14a is not shown. In a similar fashion, the back-end 28a of the body portion 16a may be adapted to include a threaded receiver (not shown), and a removable/replaceable head portion 14a element may be received therein to provide a head portion feature at the other or both ends of the gripping device housing 12a.

The body portion 16 of the gripping device housing 12 embodies the manual handling features of the line-gripping device 10, which features enable handling and operating the device 10. The body length BL of the body portion 16 is the primary determinant of overall length L of the line-gripping device 10, as in the intended embodiments, its dimension is always a greater contribution to overall length L than the dimension of the head portion 14 of the device housing 12. Additionally, the body portion 16 of the gripping device 10 houses the line through-passage 18 and the line-gripping mechanism 50 (see FIG. 2B).

The line through passage 18 extends from the back-end portion 28 of the housing body part 16 through the front-end portion 26 of the head portion 14 of the device housing 12. The passage diameter LP of the line through-passage 18 (see FIG. 3B) is selected such that line/rope of the largest diameter, intended to be practiced in a specific gripping device 10 embodiment, passes sufficiently freely within the line passage 18. The line through-passage 18 receives a line/rope 90 into one of its end portions 26/28 and passes the line 90 out through the other end portion (see FIG. 1C). In the embodiments illustrated, the line through-passage 18 is embodied in two (straight) passage sections: a front-passage section 18a and a back-passage section 18b. The two passage sections 18a/18b preferably are non-parallel, but share a common plane, and each has a passage end that is disposable in through communication with the other passage section via the release plunger line port 52 of the release plunger 20. The communicating ends of the line passage sections 18a/18b are separated within the housing body part 16 by the line-gripping mechanism 50 at the plunger release well 36. The back-passage section 18b extends from the housing back-end 28 through the housing body part 16 to the plunger release well 36. The front-passage section 18a extends from the plunger release well 36, through the housing body part 16, and on through the front-end portion 26 of the head portion 14. Each of the two line through passage sections 18a/18b have a line-gripping means 34 disposed on the passage's surface proximate the plunger release well 36 as exemplified in FIGS. 2B, 3A & 4B. The line-gripping features 34 disposed on the passage's surface engage the line 90 under the biasing force exerted on the line 90 by the line-gripping mechanism 50 and prevents the line 90 from slipping in the gripping device 10.

As exemplified in FIGS. 2B & 2C and others, the line-gripping mechanism 50 is disposed substantially within the body portion 16 of the gripping device housing 12. A release plunger 20 extends through the surface of the body portion 16 of the housing 12. As illustrated in the figures, the release plunger 20 is received in the plunger well 36 of the body portion 16 of the device housing 12. The release plunger 20 is biased in a normally engaged condition within the plunger-well 36 by a biasing means applying an “upward” force F1 on the release plunger 20 to hold it in the normally engaged position (see FIG. 2B). This is accomplished by the release plunger 20 being biased in an engaged condition within the plunger-well 36 of the device by the force F1 of the biasing means 54. The force F1 of the biasing means 54 is selected to be sufficient to hold the line-gripping features and means of the gripping device 10 in engagement with a line received in the gripping device and yet have the line-gripping mechanism 50 still be manually releasable. In the embodiments exemplified in FIGS. 2B & 2C, the biasing means 54 was a compression spring. The biasing spring 54 is received into the spring receiver/retainer well 56 in the bottom surface 70 of the release plunger 20. Bias spring seat stubs 64 in the bottom of the plunger well 36, serve to center and hold the bias spring 54 in place.

Manually operating the release plunger will deactivate/disengage the line gripping mechanism 50 of the line-gripping device 10. Depressing the release plunger 20 allows a line/rope to be loaded into the gripping device 10 or released from it. The biasing spring 54 continuously acts (applies a force) on the release plunger 20 to hold it in a normally engaged condition. To operate the line-gripping mechanism 50, a user applies a “downward” force F2 manually to the top surface 72 of the release plunger 20. While depressing the release plunger 20 to hold the line-gripping mechanism 50 in the deactivated/released condition, the user may load a line 90 into the gripping device 10, or adjust the gripping device position on the line 90. When the release plunger 20 is released, the line gripping mechanism is automatically activated/engaged.

As shown in FIGS. 5A & 5B, the release plunger 20 has a release height RH, and a release plunger line-port 52 passing through the release plunger 20 from a plunger front-surface 66 through a plunger back-surface 68. The release plunger line-port 52 is positioned along the height dimension RH of the release plunger 20, so that depressing the release plunger 20 will substantially communicate (align) the release plunger line-port 52 with the housing line passages 18a/18b of the device housing 12. Subsequently, when the release plunger 20 is released, the plunger line-port 52 will be biased to be (at least partially, see FIGS. 2B & 2C) offset from the line through-passages 18a/18b, and disposed to hold a line received in the line through-passage 18 in frictional engagement with line-gripping feature/surfaces 34/62 of the device housing 12 and the release plunger 20. In the embodiments illustrated, the release plunger 20 was practiced with a rectangular cross-section through its release height RH. However, one of skill in this art would know how to practice the release plunger 20 with a different cross-section, such as that of an oval.

As exemplified in FIGS. 5B & 5C, the release plunger 20 has a release width RW that is determined in consideration of the diameter LC of the release plunger line-port 52, such that the wall thickness of the release plunger 20, adjacent the plunger line-port 52, is sufficient withstand the force applied to operate the plunger 20. As shown in FIG. 5D, the release plunger 20 has a release plunger depth/thickness RD. The plunger depth/thickness RD is also determined in consideration of the diameter LC of the release plunger line-port 52, such that the strength of the walls of the release plunger 20, adjacent the plunger line-port 52, is sufficient withstand the force applied to operate the plunger 20, and also to provide a cross-section at the plunger top-surface 72 to facilitate manual operation of the release plunger 20.

Travel of the release plunger 20 is limited in the one dimension along its release height RH. Travel of the release plunger 20 is limited in the “upward” direction by the release stop tab/tabs 58 on the plunger 20 (see FIGS. 5A, 5C, 5D) contacting a plunger stop shoulder 60 feature of the plunger well 36 (see FIGS. 2C & 4B). The release plunger 20 has a least one plunger stop tab 58 disposed on a plunger surface 66/68 proximate the release plunger bottom surface 70. Alternatively, the release plunger 20 could have one or more plunger stop tabs 58 disposed on each of opposing plunger front, back or side surfaces proximate the release plunger bottom surface 70. The release stop tab/tabs 58 have a tab reach TR that extends beyond the bottom surface 70 of the release plunger 20. The tab reach TR is selected to be sufficient to enable a release plunger stop tab 58 to engage the stop shoulder 60 of the release well 36, and to resist the force F1 of the biasing means 54 preventing further travel of the release plunger 20. Travel of the release plunger 20 is limited in the “downward” direction by the release bottom surface 70 or the compression limit of the biasing spring 54.

A plunger line-port 52 passes through the release plunger 20 from the release plunger's front-surface 66 through the plunger's back-surface 68. The release plunger line-port 52 communicates with, but normally is offset (at least partially, see FIG. 2B) from the line through-passage 18. The plunger line-port 52 is disposed to normally exert a force F1 against a line received in the line through-passage 18. This force F1 holds the line 90 in frictional engagement with the line-gripping means 34 on the surface of the line passage sections 18a/18b of the device housing 12, and with the line-gripping features 62 of the release plunger 20, and prevents the line 90 from slipping in the gripping device 10. The line-gripping features 62 of the release plunger 20 were disposed on a lower surface of the plunger line-port 52, as illustrated in FIG. 2C.

The line holding member 30 is mounted to an external surface of the device body portion 16 of the gripping device housing 12. The line holding member 30 has an internal through channel 32 with two channel-ends, and is adapted to receive and freely pass the line 90 through either channel-end. The line holding through channel 32 has a line holding channel diameter LC. The line holding channel diameter LC is selected such that line/rope of the largest diameter intended to be practiced in the embodiment passes sufficiently freely within the line through channel 32. Generally, the line holding channel diameter LC will not be smaller than the line passage diameter LP of the device housing 12, but it can be somewhat larger, as selectable by the ordinary skilled artisan. The line holding member 30 in combination with the line through passage 18 are adapted to enable forming a loop in the line at the front part 26 of the line-gripping device 10, as set forth in Use Case 2, below. The loop thus formed can then be used to engage a docking cleat, and the line-gripping device 10 subsequently adjusted to leave as much or little slack in the line as the device user desires. Thus, these elements in combination provide a self-actuating line-gripping device for adjustably securing a line/rope 90 to a tie-down 96.

### Use Case 1: To Secure a Line Straight to a Docking Cleat

In a preferred use of the present self-actuating, line-gripping device 10 exemplified in FIG. 1C:

a.—the bitter-end 92 of a boat mooring line 90 to be secured to a docking cleat 96 is passed through the aperture 98 on the docking cleat 96.
b.—the release plunger 20 on the line-gripping device 10 is manually depressed to fully open and align the line passages 18a/18b and the plunger line-port 62.
c.—while the plunger is so depressed, the bitter-end 92 of the line 90 is in passed through the line passages 18a/18b and the plunger line-port 62, and out the back-end 28 of the device housing 12.
d.—as much or little line 90 is pulled through the line-gripping device 10 as desired by the user to adjust the position of the line-gripping device 10 on the line, and draw the line-gripping device 10, up to the docking cleat 96, and the release plunger 20 is released.
e.—upon removal of the depressive force F2 on the release plunger 20, line-gripping device 10 self-activated to engage the line 90 to prevent it from slipping in the gripping device 10.
f.—optionally, the bitter-end 92 of the line/rope 90 may knotted at the back-end 28 of the device housing 12, or be passed through the line holding member 30 and then knotted, to further prevent the line 90 from slipping in the gripping device 10 (see dashed arrow in FIG. 1C).

### Use Case 2: To Secure a Line Looped to a Docking Cleat

In an alternative use of the present self-actuating, line-gripping device 10:

a.—the bitter-end 92 of a boat mooring line 90 to be secured to a docking cleat 96 is first loaded in to the line-gripping device by:
manually depressing the release plunger 20 on the line-gripping device 10 to fully open and align the line passages 18a/18b and the plunger line-port 62; and
while the plunger is so depressed, the bitter-end 92 of the line 90 is in passed through the line passages 18a/18b and the plunger line-port 62, and out the back-end 28 of the device housing 12.
   b.—as much or little line 90 is pulled through the line-gripping device 10 as desired by the user to adjust the position of the line-gripping device 10 and form a mooring-loop (not shown) in the bitter-end 92 of the line 90, and the release plunger 20 is released.
upon removal of the depressive force F2 on the release plunger 20, line-gripping device 10 self-activated to engage the line 90 to prevent it from slipping in the gripping device 10.
then the bitter-end 92 of the line/rope 90 looped back and passed through the line holding member 30 (see dashed arrow in FIG. 1C) and then knotted to set the mooring-loop, to further prevent the line 90 from slipping in the gripping device 10.
the mooring-loop is then used to engage and be secured to the docking cleat 96.

While the above description contains many specifics, these should not be construed as limitations on the scope of the invention, but rather as exemplifications of one or another preferred embodiment thereof many other variations are possible, which would be obvious to one skilled in the art. Accordingly, the scope of the invention should be determined by the scope of the appended claims and their equivalents, and not just by the embodiments.

What is claimed is:

1. An adjustable self-actuating line-gripping device (10) for adjustably securing a line (90) to a tie-down (96), the device comprising: a device housing (12), a line-gripping mechanism (50) integral within the device housing (12), and a line holding member (30);
the device housing (12) having a head-portion (14), a substantially cylindrical body portion (16), and a line through-passage (18) passing from a back-end portion (28) of the housing body part (16) through a front-end portion (26) of the front part (14); the line through-passage (18) for receiving a line (90) into one of its end portions (26/28) and passing the line (90) out through the other end portion;
the line-gripping mechanism (50) having a release plunger (20) biased in a normally engaged position within a plunger-well (36) of the device housing (12), a biasing means (54) acting on the release plunger (20) to hold it in the normally engaged position, and a line-port (52) passing through the release plunger (20) from a plunger front-surface (66) through a plunger back-surface (68), the release plunger line-port (52) being communicating with but normally partially offset from the line through-passage (18), and disposed to normally hold a line passing through the line through-passage (18) in frictional engagement with friction surfaces (34) of the device housing (12) and the release plunger (20); and
the line holding member (30) is mounted to an external surface of the body portion (16) approximately parallel to a body length (BL) of the body portion (16), the line holding member (30) having an internal through channel (32) with two channel-ends, and adapted to receive and freely pass the line (90) through either channel-end, the line holding member (30) in combination with the line through passage (18) adapted to form a loop in the line (90) at either the front-end (26) or at the back-end (28) of the line-gripping device housing (12), these elements in combination providing for adjustably securing the line/rope to a tie-down (96).

2. The line-gripping device (10) of claim 1, wherein the front part (14) of the device housing (12) has a cross-section adapted to prevent the front part (14) from passing through an aperture (98) of the tie down (96).

3. The line-gripping device (10) of claim 1, wherein the front part (14) of the device housing (12) has a bulbous cross-section adapted to be impact resistant and to prevent the front part (14) from passing through an aperture (98) of the tie down (96).

3. The line-gripping device (10) of claim 1, wherein the front part (14) of the device housing (12) is composed of a material that is resistant to impact and abrasion for its use with the tie-down (96).

4. The line-gripping device (10) of claim 1, wherein the front part (14) of the device housing (12) is composed of a material that is protective of a boat surface.

5. The line-gripping device (10) of claim 1, wherein the front part (14) of the device housing (12) is separately replaceable.

6. The line-gripping device (10) of claim 1, wherein the line-gripping mechanism (50) disposed within the device housing (12) has a release plunger (20) having a cross-section through its release height (RH) selected from the group of cross-sections consisting of a rectangular cross-section, and an ovular cross-section.

7. The line-gripping mechanism (50) of claim 6, wherein the line-port (52) of the release plunger (20) includes line-gripping features (62) on its surface for engaging the line (90) to prevent it from slipping in the gripping device (10).

8. The line-gripping mechanism (50) of claim 6, wherein the release plunger (20) has a bottom surface (70), and a bias spring receiver well (56) inset therein.

9. The line-gripping mechanism (50) of claim 6, wherein the release plunger (20) has a least one plunger stop tab (58) disposed on a plunger surface (66/68) proximate the release plunger bottom surface (70).

10. The line-gripping mechanism (50) of claim 6, wherein the release plunger (20) has a least one plunger stop tab (58) disposed on each of opposing plunger front and back surfaces (66/68) proximate the release plunger bottom surface (70).

11. The line-gripping mechanism (50) of claim 6, wherein the biasing means (54) acting on the release plunger (20) is a compression spring.

12. The line-gripping mechanism (50) of claim 6, wherein the biasing means (54) acting on the release plunger (20) is a compression spring partially received into a spring receiver well (56) inset in a bottom surface (70) of the release plunger (20), and centered on at least one spring seat stub (64).

13. The line-gripping device (10) of claim 1, wherein the internal through channel (32) of the line holding member (30) is adapted to receive the bitter-end 92 of the line (90) passing out of the device housing (12), into and out of the internal through channel (32), and allow the bitter-end 92 of the line (90) to be knotted proximate the line holding member (30).

14. The line-gripping device (10) of claim 3, wherein the line (90) passing out of the device housing (12), is formed into a mooring-loop, and then the bitter-end 92 of the line (90) is passed into and out of the internal through channel (32), and knotted proximate the line holding member (30) to provide a mooring-loop for securing the line (90) to a tie-down (96).

15. The adjustable self-actuating line-gripping device (10), wherein the device housing (12) essentially consists of a housing left side (22) and a housing right side (24).

16. The adjustable self-actuating line-gripping device (10), wherein the device housing (12a) essentially consists of a separate head portion (14a) and a body portion (16a), the body portion (16) having a fore-end (26a) and a back-end (28a); and a body left side and a body right side.
